(19) United States
(12) Patent Application Publication
(10) Pub. No.: US 2008/0036303 A1
(43) Pub. Date: Feb. 14, 2008

(54) LINEAR MOTOR FOR IMPARTING VIBRATION TO A SUPPORTED BODY

(76) Inventor: Clive Graham Stevens, Taichung City (TW)

Correspondence Address: STREETS & STEELE, 13831 NORTHWEST FREEWAY, SUITE 355, HOUSTON, TX, 77040, US

(21) Appl. No.: 11/424,253

(22) Filed: Jun. 15, 2006

(51) Int. Cl. H02K 41/00; H02K 35/00

(52) U.S. Cl. 310/12; 310/15

(57) ABSTRACT

An electrically-powered linear motor for a whole body vibration (WBV) machine is disclosed for producing and imparting vibrations to a platform for supporting a user. The linear motor comprises one or more pairs of generally aligned coils for producing electromagnetic responses in one or more magnets, each disposed generally intermediate a pair of coils. Current is intermittently passed through the coils to produce vibrations within a desirable frequency range in the platform.

### BACKGROUND

1. Field of the Invention

The present invention is directed to a linear motor for use in a therapeutic body treatment machine. Specifically, the present invention is directed to a linear (non-rotating) motor for use in generating and imparting vibrations to a supported body.

2. Background of the Related Art

This patent relates to machines for use in strengthening, conditioning and treating the human body. Specifically, this invention is directed to machines providing whole body vibration (WBV) and, more specifically, to a linear motor for generating and delivering vibrations to a supported human body.

Controlled vibration applied to the human body, often referral to as Whole Body Vibration (WBV), provides a wide variety of benefits for persons of various ailments and illnesses. WBV is controlled vibrations applied in the vertical direction using a platform to support the user. The human body is inherently adapted to resist and overcome gravity in a vertical direction. While horizontal and variable vibration exposure is often harmful to humans, controlled vertical vibrations within a range of amplitudes may be beneficial. WBV improves and restores muscle strength for athletes and provides relief from arthritis for the elderly. WBV has been found to provide improved bone density, beneficial hormonal release, better blood circulation to extremities and even pain reduction. The discovered benefits of WBV are many, and these benefits continue to be researched.

WBV generally requires that the frequency of vibrations imparted to the body vary between 5 Hz and 60 Hz, and also that the amplitude be varied between about 2 mm and 4 mm, although some WBV machines generate vibrations with frequencies and displacements outside these ranges. There is no single frequency of vibration that is effective to treat all ailments or to strengthen persons of all sizes or weights. It is therefore desirable that a vibration motor be adapted to vary the frequency of vibration applied to the body of the user. The most useful vibration frequencies are generally between 20 and 60 Hz.

Existing WBV machines are powered by a motor with a variable frequency electronic driving device often referred to as an invertor. These rotating motors are often referred to as synchronous motors because the rotational speed of the motor is synchronized to the Alternating current (AC) wave form frequency that drives the motor. The motor rotates faster in response to an AC of a 60 Hz frequency than it will with an AC of a 20 Hz frequency.

As WBV machines are becoming increasingly popular and the benefits of WBV continue to be discovered, shortcomings of existing WBV machines leave room for improvement. WBV machines may be improved by decreasing the power consumption and by making them more compact and reliable. Existing WBV machines use electrically-powered motors having rotating shafts for transfer of power to mechanical conversion devices having offset or eccentric cams. The cams convert rotational input motion (from the rotating motor shaft output) to vertically reciprocating linear motion. Rapid and low amplitude vertical reciprocation imparts vibrations within the targeted WBV frequency and displacement ranges to a platform used to support a body.

Rotary motors used to power WBV machines make inefficient use of electrical power because of the required mechanical conversion of rotary motion to reciprocating motion through the mechanical conversion device. The horizontally generated motion from a rotary motor is wasted except to the extent that it is harnessed for upwardly and downwardly displacing the platform.

Another shortcoming of existing WBV machines is the complexity of the mechanical conversion device used in some to convert rotary motion to vertical vibration. The device used to convert rotary motor shaft output to vertical reciprocation is expensive to produce, heavy and consumes much space. The many moving components in the mechanical conversion device result in increased cost and maintenance, and decreased availability. While rotary motors are ideal for imparting rotation to other machines, they are not suited for powering purely vertical vibrations.

Some WBV machines are inefficient because they control the amplitude of the vibrations imparted to the platform and user using a supplemental motor that may be activated for high amplitude vibration. For example, one existing WBV machine utilizes two rotary motors; one primary motor that operates to produce vibrations of about 2 mm in amplitude, and one supplemental motor that, when activated along with the primary motor, contributes to produce vibrations of about 4 mm in amplitude. Other WBV machines vary the amplitude of vibrations by varying the length of a drive lever within the mechanical conversion device. The length of the drive lever may be manually adjustable, or it may be adjustable using an auxiliary motor which, like the supplemental motor, consumes even more power and contributes even further to the size, weight and maintenance requirements of the WBV machine.

What is needed is a motor that efficiently utilizes electrical power by producing only linear output motion. What is needed is a WBV machine that allows the user to electronically and controllably vary the amplitude of the vibrations of the platform. What is needed is a WBV machine that has few moving parts and reduced maintenance requirements. What is needed is a WBV machine that is lighter, has a lower cost and more portable compared to existing WBV machines.

### SUMMARY OF THE PRESENT INVENTION

The present invention achieves the above-stated objectives through the use of an electrically driven linear motor. The present invention is directed to a linear motor for driving a WBV machine. Specifically, the present invention is directed to a linear motor that consumes electrical power to intermittently generate and impart a unidirectional and vertical force to a platform supporting a user. The linear motion generated by the apparatus of the present invention generates a purely vertical output motion, as opposed to a rotary output motor requiring an eccentric mechanical linkage to convert rotary output motion to vertical reciprocating motion.

Rotating motors generally comprise a stator (stationary) and a rotor (rotating). The rotor of a rotating motor generally includes magnetically responsive material positioned to impart movement and rotation to a shaft in response to a magnetic field generated by passing a current through coils in the stator. The linear motor of the present invention does not have a rotating portion, but instead comprises a moving portion that includes at least one magnet that responds to a magnetic field imposed by passing a current through adjacent coils. The magnet, which may be a disc permanent magnet or an electromagnet, is disposed generally intermediate a pair of counter-wound coils electrically coupled one to the other. The poles of the magnet are strategically positioned near the coils to achieve vertically upward displacement of the magnet upon passing a current through the counter-wound coils.

The linear motor of the present invention is controllable by manipulation of the frequency and the voltage applied to the coil assembly. An AC wave form conditioning device, commonly known as an invertor, may he used for conditioning the frequency of the electrical power delivered to the WBV machine. The linear motor of the present invention produces vibrations at a frequency that coincides with the frequency of the conditioned AC delivered to the coils of the linear motor. Controlling the frequency of the electrical power delivered to the linear motor of the WBV machine is a preferred method of controlling the frequency of vibrations imparted to the platform and the supported user. The input AC commonly available from modern electrical grids is transformed by the invertor into direct current, and this direct current is then transformed into a variable alternating output current. The invertor provides control of the output frequency and control of the frequency of vibrations produced by the linear motor of the present invention.

The other primary control parameter is the voltage. At a constant load, increasing or decreasing voltage of the AC current applied to the coil assembly results in a proportionate increase or decrease in the current and the power, and the amplitude of the vibrations produced by the linear motor will track the voltage. This is a key advantage to the present invention. An additional advantage provided by the linear motor of the present invention over a typical rotating motor is the capacity to controllably vary the amplitude of the displacement of the platform using an electrical controller to vary the voltage of the electrical current provided to the coil pairs. The amplitude of the vibrations of the moving portion of the linear motor is controlled by the amount of electrical power delivered to the motor.

The foregoing and other objects, features and advantages of the invention will be apparent from the following more particular description of a preferred embodiment of the invention, as illustrated in the accompanying drawings wherein like reference numbers represent like parts of the invention.

### BRIEF DESCRIPTION OF THE DRAWINGS

FIG. 1 is a perspective view of whole body vibration machine containing the linear motor of the present invention.

FIG. 2 is an exploded view of the linear motor of the present invention showing an arrangement of disc magnets and steel plates.

FIG. 3A is a perspective view of the interior chamber of the housing of one embodiment of the linear motor of the present invention having an alignment post and an arrangement of support springs.

FIG. 3B is a perspective view of the spatial relationship among the coil pairs disposed within the housing.

FIG. 4 is a perspective view of the disc magnets and the steel plates of one embodiment of the motor of the present invention in their assembled relationship.

FIG. 5 is a view of a control console that may be used with the linear motor of the present invention.

### DETAILED DESCRIPTION OF THE PRESENT INVENTION

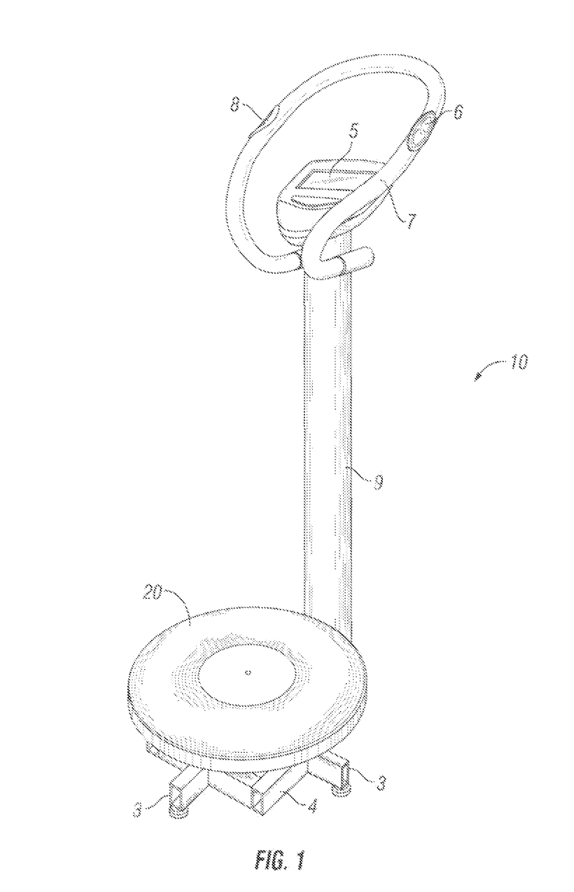

FIG. 1 is a perspective view of whole body vibration machine 10 containing a linear motor (not shown) disposed underneath the platform 20. The platform 20 is adapted for supporting the feet of a human in the standing position, although the platform may be easily adapted for supporting and imparting vibrations to a human or an animal in a variety of positions, including suspended positions. The WBV machine 10 is supported by a plurality of supports 3 that are coupled to a frame 4. The frame 4 supports a vertical column 9 that supports a set of controls 6, 8 and a handrail 7. The vertical column 9 may also support a display panel 5 that may be adapted for providing the user with information such as time, amplitude and frequency of vibrations, duration of the WBV treatment, visual entertainment, user pulse, etc.

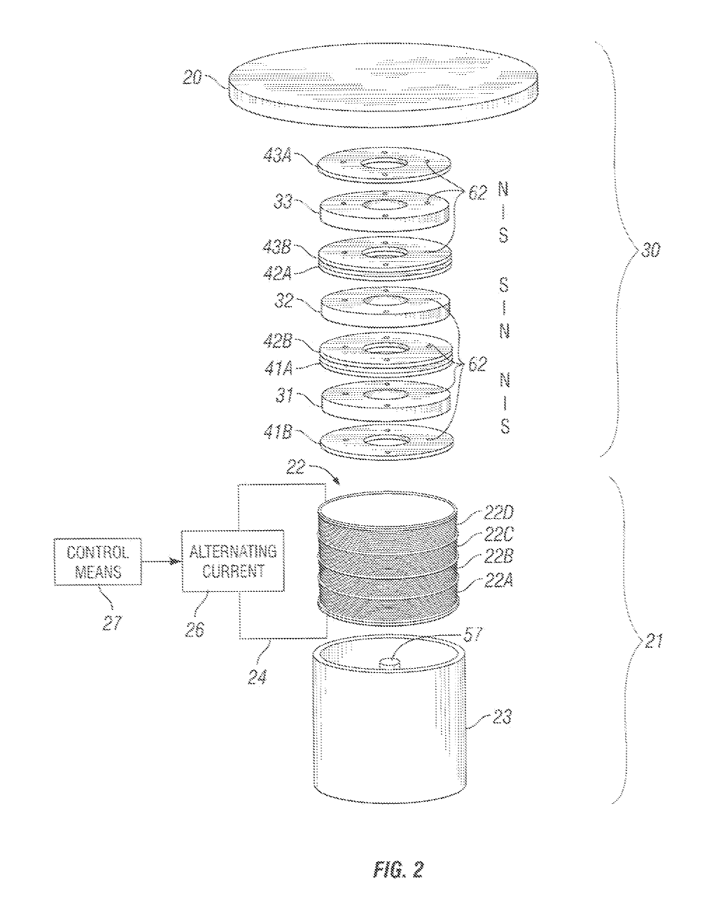

FIG. 2 is an exploded view of one embodiment of the linear motor of the present invention showing the moving portion 30 and the stator 21. The stator 21 generally comprises a housing 23 for retaining and supporting a coil assembly 22 comprising three pairs of coils, each pair comprising two adjacent counter-wound coils of at least one conducting wire, preferably a copper wire. The stator 21 further comprises a housing 23 that retains and supports the three coil pairs in a generally parallel relationship one to the others, and each relative to its pair member.

FIG. 2 also shows an exploded view of the moving portion 30 comprising generally aligned disc magnets 31, 32, 33, each “sandwiched” between steel discs 41A and 41B, 42A and 42B, and 43A and 43B, respectively, to form a stack of discs. Bottom disc magnet 31 is shown disposed between steel disc pair 41A and 41B, middle disc magnet 32 is shown disposed between steel disc pair 42A and 42B, and top disc magnet 33 is shown disposed between steel disc pair 43A and 43B. Each steel disc pair strategically conditions and redirects the magnetic field of the disc magnet disposed intermediate the steel disc pair to enhance the electromagnetic response imparted to each disc magnet upon electrical excitation of the adjacent coil pair. The steel plates manage the large amount of magnetic flux that may be in the hundreds of amps.

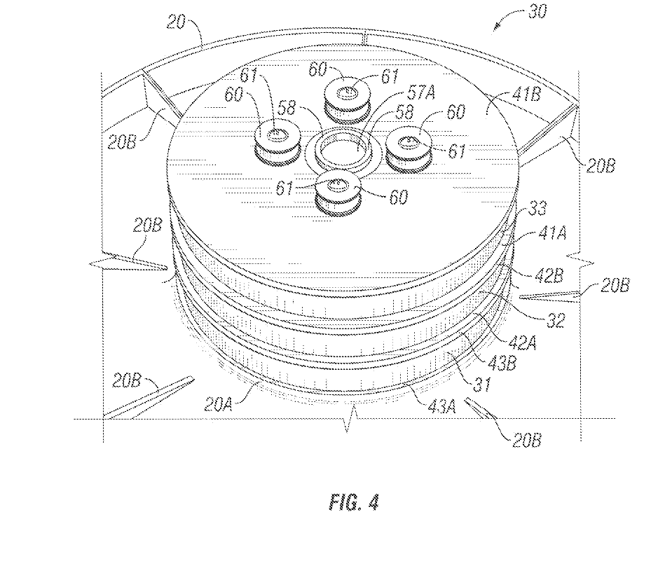

The magnetic flux produced by each disc magnet 31, 32 and 33 is directed by the steel plate pairs 41A and 41B, 42A and 42B, and 43A and 43B, respectively, that “sandwich” each disc magnet. As shown in FIG. 4, there is little or no clearance between the pairs of steel discs and the disc magnet intermediate each pair in this embodiment of the assembled linear motor of the present invention. The separation of these components is shown for purposes of clarity in the exploded view in FIG. 2. FIG. 4 shows that the discs and magnets in the assembled motor are secured together using a tension clamp disposed through the center of the stack.

In the embodiment of the present invention shown in FIG. 2, the disc magnets 31, 32, 33 and the steel disc pairs 41A and 41B, 42A and 42B, and 43A and 43B have apertures that are generally aligned. The disc magnets and steel discs form a moving portion 30 that is adapted for being vertically movably received within the bore of the generally tubular housing 23. The coil assembly 22 comprising coils 22A, 22B, 22C and 22D is shown removed from the housing 23 for purposes of illustration.

The embodiment of the present invention shown in FIGS. 2 and 4 has a central moving portion containing magnets, and a circumferential stator having coils. It is within the scope of the present invention to produce vibrations using coils secured in a moving central portion and coupled to a source of current with generally flexible wire, and using the coils to produce an electromagnetic response in the central moving portion using a circumferential stator portion comprising one or more magnets secured in position to produce the electromagnetic response in the moving central portion. It is also within the scope of this invention to use a central static portion comprising one or more magnets surrounded by a vertically movable coil housing coupled to an electrical source using flexible wire. All of these embodiments would operate to produce controlled vibrations using the same principle; that is, passing a controlled and conditioned current through coils to produce intermittent electromagnetic responses within a magnetic field to produce vibration.

The coils of the housing 23 may be permanently secured or removably securable within the housing 23. The housing 23 may be made of a generally magnetically conductive material, such as a low carbon metal. The coils may be formed on an electrically non-conducting material, such as a composite polymer.

As shown in FIG. 2, the disc magnets 31, 32 and 33 are strategically arranged so that each disc magnet repels the adjacent disc magnet. For example, the bottom disc magnet 31 has its north pole “N” disposed upwardly toward (the middle) disc magnet 32, and its south pole “S ” disposed downwardly; (middle) disc magnet 32 has its north pole “N” disposed downwardly to oppose the like pole of (the bottom) disc magnet 31 and its south pole “S” disposed upwardly toward (the top) disc magnet 33, and (top) disc magnet 33 has its north pole “N” disposed upwardly and its south pole “S” disposed downwardly to oppose the south pole of (middle) disc magnet 32. Aggregation of magnetic flux by forcing like poles into close proximity contributes to a greater overall electromechanical force upon the passage of current through the coils. This arrangement may provide significant magnetic cushioning of the transfer of vibrations from the moving portion 30 of the linear motor to the platform 20 displaced by electromagnetic force applied to the moving portion 20.

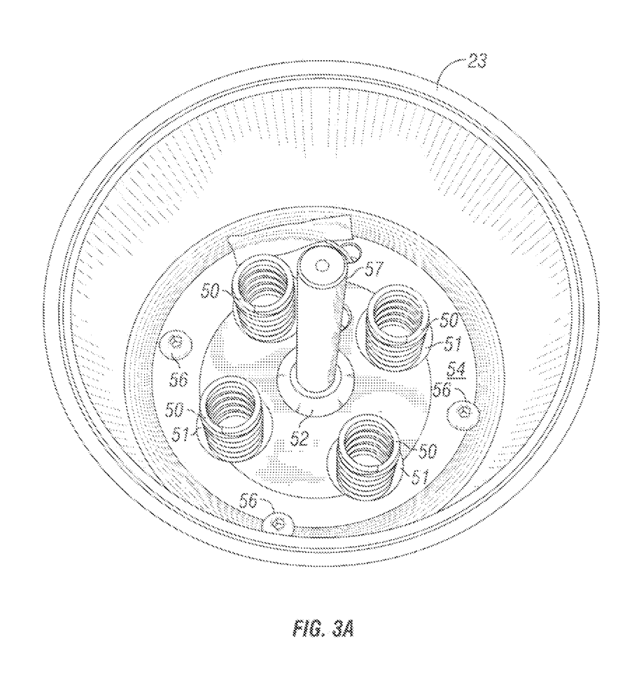

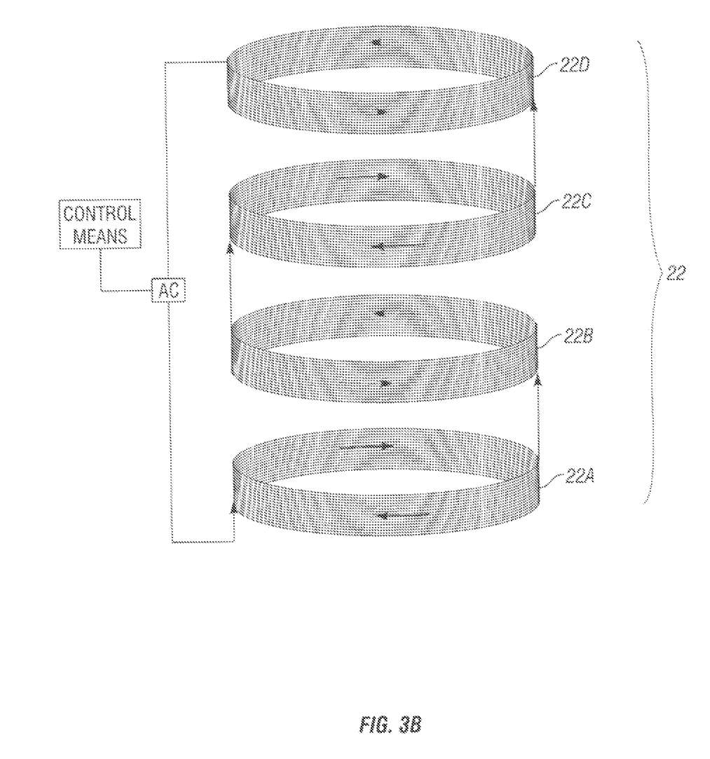

FIG. 3B shows the coil assembly 22 comprising a set three pairs of counter-wound coils, 22A and 22B, 22B and 22C, and 22C and 22D, each coil electrically coupled to its pair member coil, and each pair electrically coupled to the others. That is, coil 22B is counter-wound relative to coil 22A, coil 22C is counter-wound relative to coil 22B, and coil 22D is counter-wound relative to coil 22C. Each coil is electrically coupled one to the others as is shown in FIG. 3B, which shows the direction of current in the windings of coils 22A, 22B, 22C and 22D.

The housing 23, described in more detail below, supports and positions the disc magnets 31, 32, and 33 within the zone of electromagnetic influence of the fields generated upon electrical excitation of the coil assembly 22. Specifically, disc magnet 31 is positioned intermediate coil pair 22A and 22B, disc magnet 32 is positioned intermediate coil pair 22B and 22C, and disc magnet 33 is positioned intermediate coil pair 22C and 22D. These windings are adapted to generate within each coil pair a pair of cooperating magnetic fields that impart to disc magnets 31, 32 and 33, respectively, upwardly disposed electromagnetic responses against the platform 20 with current flow. As shown to the left side of FIG. 2, the magnetic poles of disc magnets 31, 32 and 33 are arranged N-S, S-N, and N-S, respectively, such that rotational directions of current flow of coil pairs 22A-22B, 22B-22C and 22C-22D, respectively, cooperate with the arrangement of the poles of the disc magnets 31, 32 and 33 to dispose all disc magnets upwardly against the platform 20 upon electrical excitation of the coils.

FIG. 3A is a perspective view of the interior chamber 54 of the housing 23 of one embodiment of the present invention. The housing 23 has an alignment post 57 generally disposed in the center of the chamber 54 and an arrangement of support springs 50 positioned within spring wells 51. The generally circumferential arrangement of support springs 50 contact and support steel disc 41B and weight bearing upon it, including but not limited to the disc magnets 31, 32 and 33, steel discs 41A, 42A, 42B, 43A and 43B, platform 20, and the user on platform 20, when the motor is not engaged. The alignment post 57 is adapted for being slidably received within the aligned apertures in disc magnets 31, 32, 33 and steel discs 41A, 41B, 42A, 42B, 43A and 43B to prevent movement of these components against the internal wall of the housing 23.

Support springs 50 are adapted to cooperate with the frequency of vibrations produced by the moving section 30 of the linear motor. The spring constant is designed to support the user and platform when the user is supported by the platform, and to maintain the desired positioning of the disc magnets.

FIG. 3B is a perspective view of the coil assembly 22 and the counter-wound relationship among the coil pairs 22A and 22B, 22B and 22C, and 22C and 22D, that are disposed within the housing 23 to generally surround the moving portion of the linear motor (see element 30 in FIG. 2).

FIG. 4 is a perspective view of the moving portion (see element 30 of FIG. 2) of one embodiment of the linear motor of the present invention. FIG. 4 shows the moving portion 30 inverted from its normal orientation within the housing (not shown). FIG. 4 shows disc magnets 31, 32, 33 and the steel discs 41A, 41B, 42A, 42B, 43A and 43B in their assembled relationship one to the others as they are disposed within the housing (not shown in FIG. 4—see exploded view in FIG. 2) of the linear motor. The moving portion is shown in FIG. 4 in a compressed condition, that is, the stack of disc magnets and steel discs are forced into close proximity against the magnetic repulsion forces to form a compressed stack. Anti-rotation protrusions 60 are secured to the moving portion 30 using bolts 61 inserted through aligned bolt holes 62. The bolts 61 receive and cooperate with nuts (not shown) on the opposite face of the moving portion 30 are used to secure the moving portion 30 in a “stacked” configuration, overcoming the repulsion between adjacent disc magnets to compress the stack and aggregate magnetic flux at strategic locations. The anti-rotation protrusions 60 are distributed in a pattern coinciding with the positions of the support springs (see element 50 in FIG. 3A) and are adapted to be received within the coil of a spring 50 to prevent rotation of disc 43B.

Steel discs on either face of each disc magnet are magnetically secured firmly to the face of the disc magnet. Specifically, steel discs 43A and 43B are magnetically secured to the opposing faces of disc magnet 33, and steel discs 42A and 42B are magnetically secured to the opposing faces of disc magnet 32, and steel discs 43A and 43B are magnetically secured to the opposing faces of disc magnet 33. A steel disc may be magnetically secured to the round protrusion 20A extending from the underside of platform 20. Depending on the strength of the disc magnet and the load from the user, there may remain clearance between adjacent steel plates due to the magnetic repulsion forces between adjacent pairs of disc magnets. Stiffening ribs 20B are generally equally angularly distributed about the underside of the platform 20 for imparting stiffness to the platform 20. The linear bearing 58 facilitates sliding movement of the moving portion 30 relative to the alignment post 57 (shown in FIG. 3A) slidably receivable within the bore 57A of the linear bearing 58. A bushing or other device may be substituted for the linear bearing 58.

The operation of the linear motor of the present invention involves the delivery of current pulses to the coil pairs. As shown in FIG. 2, an alternating current source 26 intermittently applies a current to the wire that is wound to form each of the four coils 22A, 22B, 22C and 22D). The four coils form three pairs of counter-wound coils coupled one to the others. Upon electrical excitation, each coil pair generates a pair of magnetic fields generally aligned with the faces of the disc magnets. Coil 22A generates a magnetic field having a south pole vertically aligned with and below the south pole of disc magnet 31 to repel the disc magnet upwardly, and the south pole of the generated magnetic field from coil 22B disposed vertically aligned with and above the north pole of disc magnet 31 to attract the disc magnet 31 upwardly, for a combined upward responsive force against platform 20. The north pole of the magnetic field from coil 22B is disposed vertically aligned with and below the north pole of disc magnet 32 to repel the disc magnet upwardly, and the north pole of the magnetic field from coil 22C is disposed vertically aligned with and above the south pole of disc magnet 32 to attract the disc magnet 32 upwardly, for a combined upward responsive force against platform 20. The south pole of the magnetic field from coil 22C disposed vertically aligned with below the south pole of disc magnet 33 to repel the disc magnet upwardly, and the south pole of the magnetic field from coil 22D is disposed vertically aligned with and above the north pole of disc magnet 33 to attract the disc magnet upwardly, for a combined upward responsive force against platform 20.

Typically, the power source fed to the invertor will be AC from an electrical grid. The invertor receives the AC and first converts an AC phase to DC to produce DC with minimal “ripple”. This DC is then fed to a high side driver and a low side driver within the invertor that conditions and delivers, in harmony, the positive and negative electrical phase components, respectively, to produce a modified AC wave form fed to the linear motor. The power to the linear motor is varied by control of the voltage, and the frequency of the vibrations produced by the linear motor is varied by control of the frequency of the conditioned AC fed to the linear motor. The current wave form that exits the invertor is in effect a sine wave.

Some high-quality invertors may produce an almost pure sine wave AC, while less expensive invertor models may produce a quasi-square wave AC. Although the frequency and power delivered by the sine wave and the square wave are the same, the wave form is different. The performance of the linear motor of the present invention is less dependent on the shape of the wave form than the performance of a rotary motor. With pulsed current and strategic positioning of magnets, the summation of the like poles repelling and opposing poles attracting provides an intermittent pulsed upward and downward force against the platform 20 creating vibrations of a frequency and amplitude controllable using a control means 27.

Positioning of the disc magnet relative to the coil pair is important to the efficient and effective operation of the linear motor of the present invention. The magnet and its associated upper and lower plates must be generally positioned intermediate the coil pair for maximum effectiveness since the force imparted to the disc magnet is a function of the positioning of the magnetic field of the magnet relative to the magnetic fields generated by the coils upon electrical excitation with the intermittent current. Each coil generates a magnetic field having a north pole and a south pole, and the proper positioning of the disc magnet relative to the coil is critical to the production of a response to the current in the coil.

The linear motor of the present invention is adapted for adjusting to varying loads on the platform 20. The linear motor requires more power to produce the same frequency and amplitude of displacement for a heavier body on platform 20. The displacement of the platform 20 depends in part on the load on the platform 20 and also on the power applied to the linear motor through alternating current 26. The weight of the user standing on the platform 20 will necessarily vary among users of the WBV machine. Accordingly, in one method of the present invention, a predetermined amount of electrical power is initially applied to the coil assembly 22 of the linear motor upon activation of the linear motor to produce a displacement of the platform 20. When the user sets the displacement amplitude using the control console (see element 5 of FIG. 1), a predetermined current is applied to the linear motor to produce vibrations. A displacement amplitude sensor measures the vibration of platform 20. A feedback controller in the control means receives the measurement from the displacement sensor and adjusts the electrical current feed to the linear motor to achieve the desired displacement amplitude sought by the user.

The alternating current electrical feed to the linear motor of the present invention is conditioned using control means 27 as shown in FIG. 2. The control means may be a computer, microprocessor, or current invertor, or any device that conditions an alternating current. The linear motor of the present invention may be adapted to operate on an electrical current having almost any voltage, but preferably operates on a voltage from 12 volts to 400 volts, and most preferably, from 100 to 300 volts.

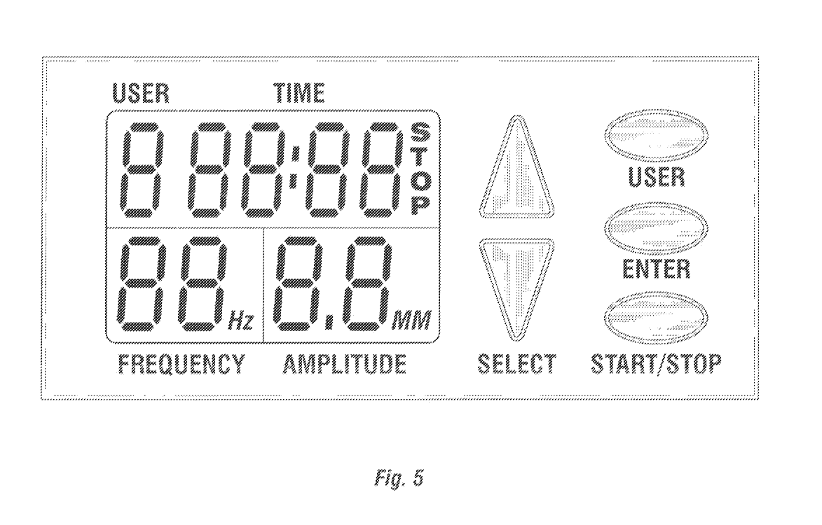

FIG. 5 is an illustration of one embodiment of display panel (see element 5 in FIG. 1) for the WBV machine having the linear motor of the present invention. The frequency of vibration of the platform 20 may be controllably adjustable, for example, within the range from 20 to 60 Hz, displacement amplitude may be controllably adjustable from 0.5 mm to 6 mm and the time typically from 1 minute to 20 minutes.

The linear motor of the present invention will function satisfactorily without the need for a pure sine wave profile on the intermittent AC current. The linear motor of the present invention does not require a pure sine wave form electrical input because it does not rotate. A significant advantage of the linear motor of the present invention is that it may be driven using one phase of an AC, whereas a rotary motor requires three phases to excite the stator, with each phase advancing the rotor of the motor 120° to achieve one revolution.

The terms “comprising,” “including,” and “having,” as used in the claims and specification herein, indicate an open group that includes other elements or features not specified. The term “consisting essentially of,” as used in the claims and specification herein, indicates a partially open group that includes other elements not specified, so long as those other elements or features do not materially alter the basic and novel characteristics of the claimed invention. The terms “a,” “an,” and the singular forms of words include the plural form of the same words, and the terms mean that one or more of something is provided. The terms “at least one” and “one or more” are used interchangeably.

The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

The term “magnet” is herein used to indicate a body having the property of attracting iron and producing a magnetic field external to itself, and specifically includes electromagnets that attract iron and produce a magnetic field when electrically excited.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A linear motor for imparting vibration to a supported body comprising:
a stator comprising two or more generally parallel and aligned coils formed from a wire coupled to an electrical source;
at least one magnet disposed generally intermediate a pair of coils;
a current conditioner for conditioning the electrical current to the pair of coils to produce an intermittent pulse of current; and
a platform movably supported by the magnet for supporting a body.

2. The apparatus of claim 1 wherein the current conditioner is adapted for producing an alternating current to the pair of coils to generate rapid vertical reciprocation of the magnet and the supported platform at a frequency of between 20 to 60 Hz.

3. An linear motor for imparting vibrations to a platform movable by a magnet comprising:
an electrical conductor formed into a pair of generally adjacent coils and coupled to a current invertor;
a current source coupled to the conductor for intermittently generating a pair of adjacent magnetic fields through the application of a alternating current applied to the conductor; and
a magnet disposed intermediate the coils in an orientation such that the intermittent magnetic field generated by the current results in a bidirectional force on the magnet.

4. A linear motor for powering a vibration machine comprising:
a stator having two or more adjacent coils formed from a conductor, each coil vertically aligned one with the other and each lying generally horizontal and generally parallel one to the other to define a vertical chamber there within;
a reciprocating assembly received and movably supported within the chamber and comprising one or more magnets, each magnet positioned generally vertically intermediate a pair of adjacent coils; and
a platform supported by the reciprocating assembly and adapted for supporting a user;
wherein intermittent pulses of electricity through the coils imparts vibration to the platform.

5. A method of producing vibrations in a platform for supporting a user comprising:
forming one or more pairs of generally aligned coils of a wire and supporting them in a housing; and
strategically arranging and positioning one or more magnets intermediate the one or more pairs of coils;
intermittently producing electromechanical responses against a platform upon passage of current through the wire.

6. The method of claim 5 wherein the one or more magnets are positioned within a generally cylindrical chamber defined by the generally aligned coils in the housing.

7. The method of claim 5 wherein the one or more magnets are positioned to generally circumferentially surround the generally aligned coils.

8. The method of claim 6 wherein the housing is secured to a base and the one or more magnets are electromechanically movable relative to the housing and the base.

9. The method of claim 6 wherein the one or more magnets are secured to a base and the housing is electromechanically movable relative to the magnets and the base.

10. The method of claim 7 wherein the housing is secured to a base and the one or more magnets are electromechanically movable relative to the housing and the base.

11. The method of claim 7 wherein the one or more magnets are secured to a base and the housing is electromechanically movable relative to the magnets and the base.

12. The methods of claim 9 wherein the housing is flexibly electrically coupled to a current source using a wire.

13. The methods of claim 11 wherein the housing is flexibly electrically coupled to a current source using a wire.

14. The linear motor of claim 1 further comprising an invertor for conditioning an alternating current provided from an electrical source.

15. The linear motor of claim 3 further comprising an invertor for conditioning an alternating current provided from an electrical source.

16. The linear motor of claim 4 further comprising an invertor for conditioning an alternating current provided from an electrical source.

17. The linear motor of claim 1 further comprising two or more magnets secured in a fixed relationship one to the other against the force of magnetic repulsion of like poles of each magnet brought into generally close proximity.

18. The linear motor of claim 4 further comprising two or more magnets secured in a fixed relationship one to the other against the force of magnetic repulsion of like poles of each magnet brought into generally close proximity.
